(19) United States
(12) Patent Application Publication
(10) Pub. No.: US 2005/0160788 A1
(43) Pub. Date: Jul. 28, 2005

(54) Method and apparatus for power management

(76) Inventor: Juraj Krajci, Coquitlam (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/765,084

(22) Filed: Jan. 28, 2004

(51) Int. Cl. G01N 29/02

(52) U.S. Cl. 73/23.2

(57) ABSTRACT

A gas sensing device comprising at least one of a thermocouple and a thermopile generating a voltage, a voltage regulator converting the voltage thereby producing a converted voltage, and a gas sensor powered by the converted voltage. Another embodiment describes a power supply for producing an output at a given voltage value. The power supply comprises an input for receiving an input voltage varying in at least a first and a second voltage ranges. The second voltage range comprises voltage values above the first voltage range. The power supply further comprises a primary voltage regulator for converting the input voltage from the first voltage range to the given voltage value when the input voltage comprises values in said first voltage range. Finally, the power supply comprises a secondary voltage regulator for converting the input voltage from the second voltage range to the given voltage value when the input voltage comprises values in said first voltage range. The secondary voltage regulator being connected in parallel with the primary voltage regulator.

### FIELD OF THE INVENTION

The present invention relates to the field of electrical power management. More specifically, the present invention is concerned with the operation and powering of electronic devices from extremely low voltage and low current power sources.

### BACKGROUND OF THE INVENTION

Gas Detectors and their Powering

Sensors of a plurality of types and chemical compositions are employed to detect and respond to dangerous gases. Such gases may include toxic, combustible, asphyxiating, radioactive, and bio-hazardous types. Such sensors include electrochemical, catalytic bead (“pellister”), infrared, metal oxide semiconductor (MOS), and thermal conductivity types to name just a few. Some sensors are specific to only a single substance and yet others are cross sensitive to a number of substances. Certain sensors are better suited or, in some cases, are the only suitable types, to detect certain specific gases or gases of a particular type. For example, while electrochemical sensors can be used to detect inorganic combustible gases such as hydrogen, they are inappropriate for the detection of organic combustible gases such as methane, gasoline, etc.

Electrochemical sensors often can be viewed as fuel cells that produce current in response to the oxidation or reduction of the target gas. Subsequently gas detectors designed using electrochemical sensors require relatively little power.

Simple equipment appropriate for the detection of a broad range of hydrocarbon-based combustible gases is normally based on MOS, pellister, or thermal conductivity sensor types. Such sensors are power hungry when compared to electrochemical types due to the nature of their operation. The principle of gas detection is via controlled combustion of the target gas or through the adsorption of molecules of the target gas onto a heated electrode surface. It is the power associated with the heating of the sensors that accounts for the relatively high power requirement.

Gas detection equipment can be basically separated into fixed-location and portable categories. Usually portable equipment is powered by either rechargeable or disposal battery cells. Batteries or line voltage usually powers fixed location equipment. Line-powered equipment may occasionally employ batteries for back-up purposes when line power fails. It is important to note that equipment that employs power hungry sensor types does not offer practical and/or economical service life when powered continuously from batteries.

Voltage Step-Up Circuits

A number of circuits are commercially available to recharge, monitor and regulate the power of batteries for use in electronic equipment. Many battery chemistries are employed for such purposes and include nickel-cadmium, nickel-metal hydride, lithium and lead-acid types. Each of these battery chemistries has differing cell voltages. Of the popular and economical types, nickel-based batteries have the lowest cell voltage of 1.2 Volts nominally and 0.9 Volts discharged. Some battery-powered equipment may employ several battery cells wired in series to produce higher system circuit voltages. The recent proliferation of cellular telephones and palm tops has driven the need for smaller, lighter power supplies that often employ only a single battery cell. Such equipment must use voltage step-up circuits to generate the higher voltages required to power the system electronics. The electronics industry has responded with a plethora of commercially available switch-mode voltage step-up power supply circuits normally referred to as “boost regulators”. Unfortunately, these boost regulators only support input voltages that represent the lowest discharged cell voltages of the lowest cell voltage types. Since 0.9 Volts is the lowest commonly encountered cell voltage in these applications, existing boost regulator circuits do not commence to operate below that voltage level, and once operating, do not continue to operate at a voltage significantly below that voltage level.

Furthermore, the general absence of batteries with a cell voltage of less than one Volt may be due to the common use of silicon-based semiconductors in modern electronic equipment. Silicon transistors have a base-emitter forward voltage (Vbe) of about 0.6V and subsequently are able to switch and operate reliably in circuits powered by even discharged nickel-cadmium batteries.

The predecessor of the silicon transistor was the germanium type with a Vbe of about 0.2 Volts. Germanium transistors are no longer widely used in modern electronic equipment.

Occasionally gas detectors (and similar safety and loss prevention equipment) must operate in a fixed location, must be completely independent from line power, and the use of batteries may be impractical due to the power requirements of the employed sensor type.

An application that may have such a requirement is gas-powered equipment such as a combustible gas-powered furnace or water heater. Such equipment may have the basic requirement that it must be able to continue to operate in the event of a line power failure. If such equipment relies on electronic circuits to perform necessary control functions or to assure safe operation, then such circuits much be powered independently from the mains power source. Depending on the power requirement of the electronic circuits, batteries of a practical size, economical cost, and acceptable shipping weight may not be appropriate for the application. Furthermore, if rechargeable batteries were to be employed, additional problems arise out of the need to provide external power for recharging, the safety aspects of off-gassing by the batteries during charging, and the limited number of recharge cycles possible before the batteries will no longer provide adequate service and must be replaced.

### OBJECTS OF THE INVENTION

An object of the present invention is to provide a method and apparatus for providing and managing power to low-current and low-power electronic devices.

### SUMMARY OF THE INVENTION

Since gas-powered furnaces and water heaters already commonly employ thermocouples and thermopile generators to generate energy from the burners or pilot lights to control gas shut-off valves, these power-producing devices lend themselves additionally as sources with which to power ancillary electronics circuits associated with said equipment.

The problem with thermocouples and thermopiles is that they produce very little power and develop only very low voltages. In the case of thermopiles, the higher energy device, the voltage obtainable is nominally in the order of 500 to 750 mV and the practical power that can be developed is approximately 20 to 30 mW. For this reason, standard silicon-based boost regulators are unable to start-up and operate using only a single traditional thermopile.

Even if existing boost regulators were able to operate from a single thermopile and were able to raise the voltage to at least the 2 Volts or so required to power traditional electronic circuits such as op-amps and microprocessors, the available instantaneous power available is too low to continuously operate equipment that additionally contains power hungry devices such as combustible gas sensors. Consider that a typical combustible gas sensor may require heater power in the range of 250 mW to several Watts. The nominal 25 mW available from a single thermopile can be orders of magnitude insufficient to power the sensor without even the additional requirement of powering the entire system that may comprise of yet other significant electrical loads such as relays and solenoids.

For this reason, methods and apparatuses were developed to store and manage the limited power of a thermopile for a long enough period to perform useful work yet short enough to achieve an adequate response time.

In one of its embodiments, the present invention relates to a gasoline vapour detector operated from a single thermopile generator. The gas vapour detector/sensor may b incorporated in a gas-powered device. The gas-powered device comprises an energy source, at least one of a thermocouple and a thermopile generating an electrical signal representative of the energy source, and a combustible gas sensor powered by the electrical signal.

In another embodiment, the present invention relates to a method for powering a gas sensor. The method comprises producing energy with a gas-powered device, producing a voltage representative of said energy with at least one of a thermocouple and a thermopile, and powering said gas sensor with said voltage.

In another embodiment, the present invention relates to a gas sensing device comprising at least one of a thermocouple and a thermopile generating a voltage, a voltage regulator converting the voltage thereby producing a converted voltage, and a gas sensor powered by the converted voltage.

In another embodiment, the present invention relates to a method for providing power to a gas sensor. The method comprises obtaining electrical power from at least one of a thermocouple and a thermopile, converting the electrical power using a voltage regulator, and providing the converted electrical power to said gas sensor.

In other embodiments, the present invention relates to a novel method for stepping up voltage from a very low level, and a power management method for power-hungry electronic instruments operating from sources of limited power.

In another embodiment, the present invention relates to a power supply for producing an output at a given voltage value. The power supply comprises an input for receiving an input voltage varying in at least a first and a second voltage ranges. The second voltage range comprises voltage values above the first voltage range. The power supply further comprises a primary voltage regulator for converting the input voltage from the first voltage range to the given voltage value when the input voltage comprises values in said first voltage range. Finally, the power supply comprises a secondary voltage regulator for converting the input voltage from the second voltage range to the given voltage value when the input voltage comprises values in said first voltage range. The secondary voltage regulator being connected in parallel with the primary voltage regulator.

In another embodiment, the present invention relates to a method for producing an output at given voltage value. The method comprises receiving an input voltage varying in at least a first and a second voltage ranges. The second voltage range comprising voltage values above the first voltage range. When the input voltage comprises values in the first voltage range, converting the input voltage to the given voltage value. Finally, when the input voltage comprises values in the second voltage range, the method comprises converting the input voltage to the given voltage value.

This document describes technologies that, used conjunctively, permit the operation of a practical and cost-effective combustible gas detector that operates using the power of only a single thermopile generator.

In an embodiment, the invention relates to a novel switch mode power supply that utilizes germanium transistors to raise the voltage of an input source from about 250 mV to a higher voltage at which conventional silicon-based circuits are allowed to operate reliably. The input power for said power supply circuit can be a single thermopile generator or any other voltage source that develops at least 250 mV.

In another embodiment, the invention relates to a novel combustible gas detection system that is able to operate on very limited amounts of input power yet which has the capability to store and release energy to the system in a way that permits adequate sensitivity and response time. Furthermore, it is additionally claimed that such a gas detection system can store and manage additional power over and above the requirements of the sensor/control circuits to power additional actuating devices such as solenoids and relays and loads attached to such devices. Another claim is that a toxic (or other deleterious) gas detection can be operated in like fashion. It is also claimed that this energy storage and management system may be employed to power other electronic equipment unrelated to gas detection but where the available input power is very low. Such equipment may be employed in the fields of safety, security, communications, etc.

### BRIEF DESCRIPTION OF THE DRAWINGS

In the appended drawings:

FIG. 1 is a schematic diagram of a step-up converter in accordance with an embodiment of the invention;

FIG. 2 is a block diagram of a power supply in accordance with an embodiment of the invention;

FIG. 3 is a block diagram of a gas detector in accordance with an embodiment of the invention; and

FIG. 4 is a schematic diagram of a gas detector in accordance with an embodiment of the invention.

### DESCRIPTION OF THE PREFERRED EMBODIMENT

Extremely Low Input Voltage Step-Up Converter

This circuit can be fabricated using discrete components or the active components may be incorporated on a single die in a monolithic integrated circuit.

To overcome the inability of silicon transistors to switch below 600 mV, this circuit employs germanium transistors to permit operation down to about 200 mV.

Embodiments based on discrete components may achieve power conversion efficiencies in the range of 50% to 60% and subsequently such circuits may be used to bootstrap power levels to the point where more efficient monolithic and conventional boost regulators may take over the power conversion function. In such an instance, the primary bootstrapping circuit may contain a sensing input that shuts of the primary supply when the secondary supply has sufficient input voltage to operate reliably. Such voltage level sensing may also allow the primary circuit to resume operation when the input voltage levels are no longer able to sustain the secondary supply.

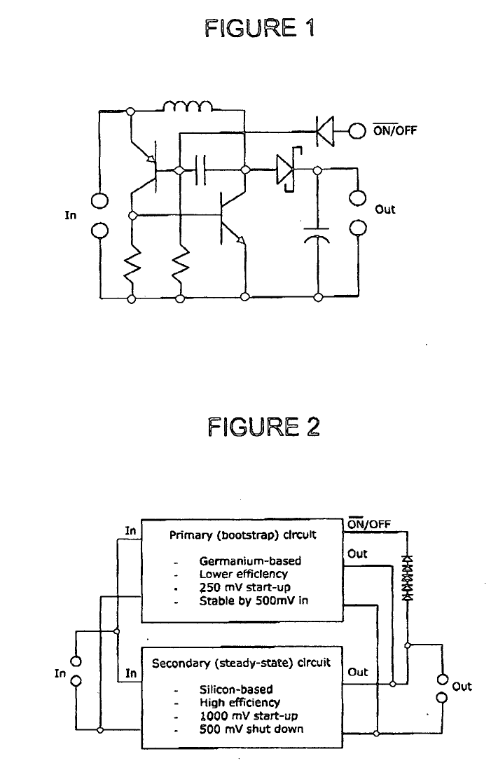

One simple embodiment of this circuit is illustrated in FIG. 1.

Using discrete germanium transistors, the circuit of FIG. 1 is able to accept input voltages of 250 mV to 1500 mV and step them up to tens of Volts under conditions of light output loading. With the application of a load of about 25 mW, output voltages in excess of 3 Volts are easily achieved. The circuit does not contain any overdriving protection components on the assumption that the instantaneous input power is very low and unable to damage components in the event of overloading, output shorting or thermal runaway. This type of circuit is particularly suited to thermopile generators as the energy produced by them is insufficient to damage general purpose germanium transistors under fault conditions. The coil and flyback coupling capacitor were selected to produce a switching frequency of about 5 kHz to 10 kHz with typical values being in the range of 680 μH and 1000 pF respectively. Conversion efficiency was observed to be in the range of 45% to 60% depending on severity of output loading and input voltage levels.

FIG. 2 illustrates how the circuit above may be incorporated in a two-stage power supply that operates with greater efficiency post-start up through the use of a secondary conventional silicon-based monolithic boost regulator. Boost regulators that sense their own output voltage are available and start to convert power reliably once the sensed voltage reaches an acceptable threshold level. Typically this level is 1000 mV. Such regulators are capable of continuously switching reliably down to about 500 mV thereafter they spontaneously shut down.

With an output load of about 2 mA, the circuit above is able to produce an output voltage from the primary circuit of about 1000 mV with an input of about 300 mV. By the time the input voltage rises to 400 mV, the primary circuit produces sufficient voltage to reliably start the secondary circuit. As input voltage rises further, the voltage produced by the secondary circuit exceeds the forward voltage of the shown silicon series diodes and this in turns shuts off the primary circuit. With proper selection of output voltage regulation components, the secondary circuit is able to generate and maintain stable output voltages necessary to power conventional silicon-based circuits. Should the input voltage drop below about 500 mV, the secondary circuit shuts down and the primary circuit takes over again. The primary circuit continues to provide output power down to input voltages as low as about 250 mV. At this point, regulation of output voltage, depending on the output load, is no longer reliable.

Energy-Efficient Combustible Gas Detector

An energy-efficient combustible gas detector can be constructed that utilizes a MOS gas sensor that normally requires 275 mW when employed conventionally, but where the entire detection system is able to be powered with as little as 25 mW input power at about 500 mV. This circuit could also support other power hungry sensor types.

This detection system employs the more efficient two-stage power conversion system described earlier in this document and has been optimized to operate from a single thermopile generator heated by a standard pilot light as used in gas-powered furnaces and water heaters.

It is possible to construct this detection system using all analog components such as op-amps and/or comparators. Alternatively, the system may be comprised of digital components such as logic gates or a microprocessor. Additionally, hybrid analog/digital designs are also possible.

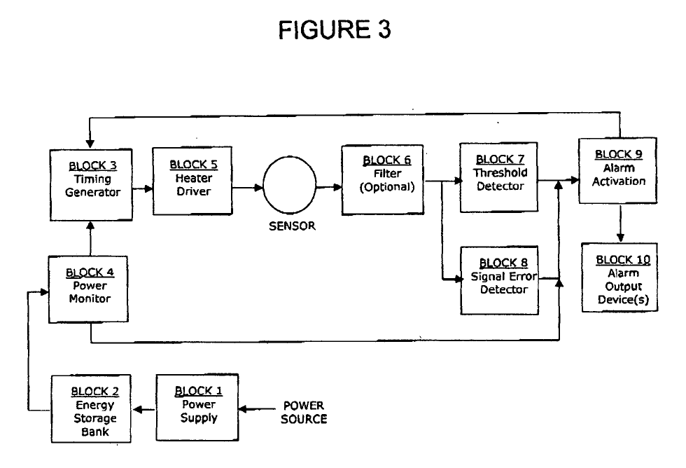

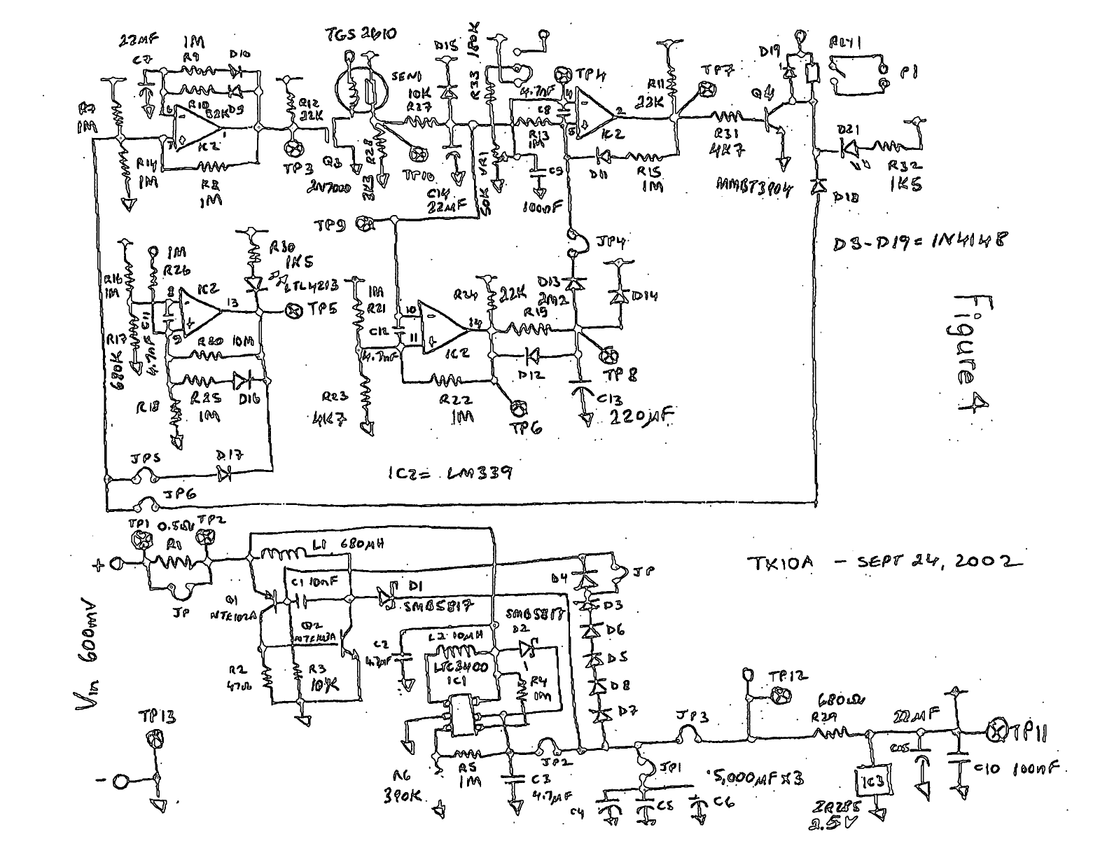

For the purposes of illustration, an analog-only embodiment is described in FIG. 3.

Block 1—Power Supply

Two-stage power supply. Stage 1 is comprised of germanium transistor switch mode step-up power supply that acts as a bootstrapping voltage source for Stage 2. For simplicity, Stage 1 does not regulate its output voltage as, once its bootstrapping function has been completed, Stage 2 performs output voltage regulation. Stage 2 is comprised of a conventional silicon-based switch mode boost converter with high efficiency and output voltage regulation. Output regulation is set to 4.5 Volts and a secondary precision voltage reference establishes a stable 2.5 Volt rail to power system circuits with less overall power dissipation and in order to create precision voltage references. Both Stage 1 and Stage 2 are powered by the same input power source, which in this case is a thermopile generator that produces about 650 mV during steady state operation. When heat is first applied to the thermopile, the input voltage rises to 250 mV and Stage 1 commences to switch and step up the input voltage. At around 400 mV input, Stage 1 is producing over 1000 mV output and when that is sensed by Stage 2, it commences to switch co-incidentally with Stage 1. At around 500 mV input, the combined Stage 1 and Stage 2 output voltage exceeds the forward voltage of the series diodes and Stage 1 shuts off. From this point on, Stage 2 continues to provide all the system power while the input voltage remains above 500 mV.

Block 2—Energy Storage Bank

This is a bank of electrolytic capacitors wired in parallel to achieve a flatter physical profile. A single large capacitor may be used instead. A total capacitance of 50,000 microfarads was employed in an embodiment of the invention. All power produced by the two-stage power supply is stored in the capacitor bank for later periodic release to the sensor heater. The power supply regulates its output to 4.5 Volts and this is done mainly to prevent exceeding the rated voltage of the capacitors. When a sudden draw is made on the capacitors' stored energy, the tank voltage can dip significantly below 4.5 Volts and a control circuit described below prevents depletion of the tank below 3.75 Volts. Since the regulation of the tank voltage varies according to load, a 2.5 Volt precision reference establishes general system power in order to reject the effects of the varying tank voltage. The tank voltage is only applied to non-control system loads such as the sensor heater and the alarm activation relay.

Block 3—Timing Generator

This circuit determines when it is appropriate to dump stored energy into the sensor heater. This determination can be based synchronously on a fixed duty cycle or asynchronously by sensing an adequate energy tank voltage level. In an embodiment, the steady state power generation of the thermopile generator is fairly constant and the energy in the tank capacitors is replenished at a fixed rate. Thus, a comparator configured as a relaxation oscillator is used to establish the period. For the MOS sensor employed in this embodiment, a period of 800 ms drive time and 24-second replenishment time was utilized. This duty cycle assures that a) the sensor heater receives a decent voltage (4.5 V) at the beginning of the drive cycle, b) does not deplete the energy tank below a voltage that is no longer useful, and c) allows sufficient time to restore the original pre-drive tank level in the allotted time even if the input power should drop by 20% from nominal. The timing generator can be shut down by two sources, viz. the Power Monitor and the Alarm Activator. Since the timing generator controls the sensor heater driver, it is not practical to allow the sensor heater to begin to draw energy when the system is first starting up. Thus the Power Monitor suppresses drive cycles until the tank voltage is acceptable. Furthermore, when the detector triggers an alarm and attempts to activate an alarm device such as a relay, sensor driving is terminated to permit all available energy to be used to power the alarm device. The timing generator lends itself easily to implementation via a microprocessor with real-time A/D feedback of the tank voltage.

Block 4—Power Monitor

This comparator suppresses the generation of heater driver pulses until the tank voltage reaches at least 4 Volts. This speeds the start-up time by not wasting energy by driving the heater with impractical power levels while the tank capacitors are still charging. Furthermore, the power monitor has hysteresis of a type that generates an alarm and shuts down the timing generator if the Input power should falter after original start-up.

Block 5—Heater Driver

The heater driver is a low on-resistance FET that, when driven by the timing generator, allows stored tank energy to be dumped into the sensor heater. The timing generator assures that the application of energy is performed for only a precise period of time in order to not deplete the tank beyond the point of diminished return. While this short and periodic application of energy to the sensor heater does not produce the sensitivity and response time normally expected from MOS sensors whose heaters are driven continuously, it does produce a period of heightened sensitivity during which signal measurements and alarm determinations can be made.

Block 6—Filter

This optional low pass filter on the sensor's electrode signal is used to prevent transient electrical noise from inadvertently triggering an alarm or a sensor signal error event.

Block 7—Threshold Detector

This comparator utilizes a potentiometer to establish the alarm trip threshold based on the precision 2.5 Volt reference. Optionally, the hysteresis of the circuit can be set in such a way as to hold the detector in an alarm state even if the alarm-causing gas presence was transient in nature. This is another section of the system which lends itself to ready implementation in a microprocessor-based design.

Block 8—Signal Error Detector

This sample-and-hold circuit continuously monitors the sensor's output signal to make sure that it exceeds a minimum threshold level that indicates proper operation of the heater drive circuit and continuity of the electrode wires. The circuit is enabled after power has stabilized post power-up and monitors the tell-tale increase in sensor signal strength co-incident with each heater drive cycle. If several heater drive cycles fail to produce the expected response then the sensor is determined to be defective or dislodged and an alarm is generated.

Block 9—Alarm Activation

This circuit mixes the various alarm-producing signals. These alarm signals are produced elsewhere in the circuit in response to a) a significant gas presence, b) loss of sensor signal, and c) degradation in input power. The alarm activation circuit sources power to Alarm Output Devices. In this embodiment, a relay is used. Since energizing a relay depletes tank energy, the Timing Generator is shut down when an alarm is activated to prevent energy from needlessly being depleted at such a time with continued sensor heater drive cycles.

Block 10—Alarm Output Device(s)

In this embodiment, a relay is used to shut of the gas to the appliance that is being monitored.

Although the present invention has been described hereinabove by way of preferred embodiments thereof, it can be modified, without departing from the spirit and nature of the subject invention as defined in the appended claims.

1. A gas-powered device comprising:
a. an energy source;
b. at least one of a thermocouple and a thermopile generating a voltage representative of said energy source; and
c. a gas sensor powered by said voltage.

2. A method For powering a gas sensor, said method comprising:
a. producing energy with a gas-powered device;
b. producing a voltage representative of said energy with at least one of a thermocouple and a thermopile; and
c. powering said gas sensor with said voltage.

3. A method for providing power to a gas sensor comprising:
a. obtaining electrical power from at least one of a thermocouple and a thermopile;
b. converting said electrical power using a voltage regulator; and
c. providing said converted electrical power to said gas sensor.

4. The method of claim 3 wherein said electrical power converting comprises using a germanium transistor.

5. A gas sensing device comprising:
a. at least one of a thermocouple and a thermopile generating a voltage;
b. a voltage regulator converting said voltage thereby producing a converted voltage; and
c. a gas sensor powered by said converted voltage.

6. The gas sensing device of claim 5 wherein said voltage regulator comprises an input and a germanium transistor connected to said input.

7. A power supply for producing an output at a given voltage value comprising:
a. an input for receiving an input voltage varying in at least a first and a second voltage ranges, said second voltage range comprising voltage values above said first voltage range;
b. a primary voltage regulator capable of converting said input voltage from said first voltage range to said given voltage value when said input voltage comprises values in said first voltage range; and
c. a secondary voltage regulator capable of converting said input voltage from said second voltage range to said given voltage value when said input voltage comprises values in said first voltage range, said secondary voltage regulator being connected in parallel with said primary voltage regulator.

8. A method for producing an output at a given voltage value comprising:
a. receiving an input voltage varying in at least a first and a second voltage ranges, said second voltage range comprising voltage values above said first voltage range;
b. when said input voltage comprises values in said first voltage range, converting said input voltage to said given voltage value; and
c. when said input voltage comprises values in said second voltage range, converting said input voltage to said given voltage value.

9. A voltage regulator for producing an output at a given voltage value comprising:
a. an input for receiving an input varying in a voltage range; and
b. a germanium transistor connected to said input.
